(19) United States
(12) Patent Application Publication
(10) Pub. No.: US 2017/0267577 A1
(43) Pub. Date: Sep. 21, 2017

(54) COMPOSITIONS AND METHODS FOR MICROPATTERNING SUPERHYDROPHOBIC SURFACES

(71) Applicant: KING ABDULLAH UNIVERSITY OF SCIENCE AND TECHNOLOGY, Thuwal (SA)

(72) Inventors: Peng Wang, Thuwal (SA); Lianbin Zhang, Thuwal (SA)

(21) Appl. No.: 15/310,176

(22) PCT Filed: May 11, 2015
(86) PCT No.: PCT/IB2015/000833

§ 371 Date: Nov. 10, 2016

Related U.S. Application Data
(60) Provisional application No. 61/991,807, filed on May 12, 2014.
(60) Provisional application No. 62/001,111, filed on May 21, 2014.

(51) Int. Cl. C03C 17/32; B41M 5/00; B05D 1/02; C09D 179/02; B05D 3/02; B05D 5/00; C09D 5/00; B41J 2/01; B05D 1/26

(52) U.S. Cl. CPC C03C 17/32; B41J 2/01; B41M 5/0047; B41M 5/007; B41M 5/0023; B05D 1/02; B05D 1/26; B05D 3/0272; B05D 5/00; C09D 5/00; C09D 179/02; C03C 2217/76; C03C 2218/119

(57) ABSTRACT

Described herein are patterned superhydrophobic surfaces, substrates, devices, and systems including the patterned superhydrophobic surfaces, and methods of making and uses thereof.

### CROSS-REFERENCE TO RELATED APPLICATIONS

This application is the National Stage of International Application No. PCT/IB2015/000833, filed 11 May 2015, which claims the benefit of and priority to U.S. Provisional Application Ser. No. 62/001,111 filed on 21 May 2014, having the title “Compositions and Methods for Micropatterning Superhydrophobic Surfaces” and U.S. Provisional Application Ser. No. 61/991,807 filed on 12 May 2014, having the title “Compositions and Methods for Micropatterning Superhydrophobic Surfaces”, the contents of all of which are incorporated by reference as if fully set forth herein.

### BACKGROUND

Water scarcity is a severe problem in various regions of the world, particularly in semi-arid desert regions, land-scarce countries, and in countries with high levels of economic activity. In these regions, the collection of water from other sources than ground or surface water is important. Such an alternative source of water can be atmospheric water (e.g. fog). As such, there exists a long-felt and unmet need for improved systems and methods of collecting water from alternative sources than ground or surface water.

### SUMMARY

Superhydrophobic surfaces can be useful in collecting water, especially from alternative sources. In various aspects, we provide herein methods for producing superhydrophobic surfaces and superhydrophobic surfaces produced therefrom. In one or more aspects we provide methods for producing hydrophilic regions, for example micropatterns, on superhydrophobic surfaces. The hydrophilic regions can be superhydrophilic regions. In various aspects we provide a direct method for producing the hydrophilic regions on the superhydrophobic surfaces, that can be for example a one-step method. In one or more aspects the hydrophilic regions, for example superhydrophilic regions, can be produced on the superhydrophobic surfaces using printing technology, such as inkjet printing technology among others described herein.

In one aspect, described herein are superhydrophobic surfaces containing one or more superhydrophilic regions on at least part of the superhydrophobic surface, where the superhydrophilic regions comprise polydopamine. The superhydrophobic surface can be deposited on a substrate. The substrate can be a solid or semi-solid substrate. Solid substrates can contain at least one compound selected form the group consisting of: glass, metal, metal oxide, plastic, and combinations thereof. Semi-solid substrates can contain at least of compounds selected from the group consisting of: an organic gel, a polymer gel, rubber, an elastomer, and combinations thereof. The superhydrophilic region(s) of the superhydrophobic surface(s) described herein can be configured on the superhydrophobic surface to form micropattern(s) on the superhydrophobic surface. The micropatterns can be made of or contain one or more features. The size of one dimensions of each of the one or more features of the micropattern(s) can be above 5 nm. Each of the one or more features can be configured as a microdot, microline, or a combination thereof. In some embodiments, the one or more features are discrete from each other and are separated from each other by the superhydrophobic surface. In other embodiments, at least two features of the one or more features are in direct contact with one another and are not separated by the superhydrophobic or hydrophobic surface at a point within each of the at least two features.

In other aspects, compositions for making the superhydrophobic surface(s) are described herein. The composition can contain a hydrophilic species and a tri-solvent. The tri-solvent can contain three solvents where the first solvent is water or a tris buffer, where the second solvent is selected from the group consisting of ethanol, propanol, methanol, acetone, tetrahydrofuran and isopropanol, and the third solvent is selected from the group consisting of: ethylene glycol, glycerol, dimethyl sulfoxide, and dimethylformamide. The hydrophilic species can be selected from from the group consisting of dopamine, dopamine-quinone, alpha-methyldopamine, norepinephrine, 3,4-dihydroxyphenylalaninie (DOPA), L-DOPA, alpha-DOPA, droxidopa, 5-hydroxydopamine, and combinations thereof.

In further aspects, methods of modifying a superhydrophobic surface are described herein. The method can contain the steps of depositing a composition on a region of the superhydrophobic surface, wherein the composition comprises a hydrophilic species and a solvent and incubating the superhydrophobic surface having the deposited composition, where incubating continues until the composition is substantially polymerized to form a superhydrophilic region on the superhydrophobic surface. The hydrophilic species can be selected from the group consisting of dopamine, dopamine-quinone, alpha-methyldopamine, norepinephrine, 3,4-dihydroxyphenylalaninie (DOPA), L-DOPA, alpha-DOPA, droxidopa, 5-hydroxydopamine, and combinations thereof. The solvent consists of at least one of the following: water, ethanol, methanol, isopropanol, propanol, acetone, tetrahydrofuran, dimethsulfoxide, nitromethane, pyridine, ethylene glycol, diethylene glycol, glycerol, dimethylformamide, and combinations thereof. The incubation can occur for about 1 hour to about 72 hours. Deposition of the composition can occur via a physical deposition method. The physical deposition method can be selected from at least one method selected form the group consisting of: inkjet printing, dip-pen lithography, microcontact printing, and spraying.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIGS. 1A-1C demonstrate various aspects of one embodiment one embodiment of liquid droplets containing dopamine being deposited on a superhydrophobic or hydrophobic substrate by an inkjet printer. FIG. 1A graphically demonstrates one embodiment of liquid droplets containing dopamine being deposited on a superhydrophobic or hydrophobic substrate by an inkjet printer. FIG. 1B graphically demonstrates an enlarged view of the interface between the superhydrophobic or hydrophobic surface and the liquid droplet of FIG. 1A, which demonstrates the Wenzel wetting behavior of the dopamine droplet on the superhydrophobic or hydrophobic surface. Also shown in FIG. 1B is the polydopamine that forms at the interface. FIG. 1C demonstrates a general polymerization reaction that can form polydopamine of FIG. 1B.

FIGS. 2A-2B shows scanning electron microscope (SEM) images demonstrating a top view (FIG. 2A) and a cross-sectional view (FIG. 2B) of a prepared superhydrophobic surface on a glass slide substrate.

FIGS. 3A-3B shows representative images of liquid droplets on one embodiment of a superhydrophobic surface. FIG. 3A shows an image of a water droplet on one embodiment of a superhydrophobic surface where the contact angle is about 157 degrees. FIG. 3B is a snapshot image from a contact angle measurement video, which demonstrates rolling of the water droplet off one embodiment of the superhydrophobic surface upon a slight tilt of the superhydrophobic surface and a sliding angle of about 1 degree or less.

FIGS. 4A-4C shows representative images of one embodiment of liquid droplets prepared using a tri-solvent system. FIG. 4A shows an image that demonstrates the shape of one embodiment of a tri-solvent liquid droplet containing water, ethanol, and ethylene glycol (1:1:1, v/v/v) without dopamine after the droplet has been placed on one embodiment of a superhydrophobic surface at a tilt angle of 0 degrees. The contact angle of the droplet is about 130 degrees. FIG. 4B shows an image that demonstrates the behavior of the droplet of FIG. 4A in which the tilt angle of the surface is increased to about 90 degrees (surface is perpendicular to horizontal). FIG. 4C shows an image that demonstrates the behavior of the droplet of FIG. 4A in which the tilt angle of the surface is increased to about 180 degrees (the surface is inverted).

FIGS. 5A-5B show representative images from an optical microscope showing the top-view images of the water droplet of FIG. 4A. FIG. 5A shows a top-view image from an optical microscope that demonstrates the interface between the tri-solvent droplet of FIG. 4A and one embodiment of the superhydrophobic surface. FIG. 5B shows a top-view image from an optical microscope that demonstrates the interface between a water droplet and the superhydrophobic surface of FIG. 4A.

FIGS. 6A-6C show representative images of one embodiment of liquid droplets prepared from a dopamine (about 5 mg/mL)-tri-solvent (tris buffer solution, ethanol, ethylene glycol at a ratio of 1:1:1 (v/v/v)) on one embodiment of a superhydrophobic surface at different tilting angles: 0 degrees (contact angle of about 128 degrees) (FIG. 6A), about 90 degrees (FIG. 6B), and about 180 degrees (FIG. 6C).

FIG. 7 shows a top-view image from an optical microscope that demonstrates the interface between the dopamine-tri solvent liquid droplet of FIGS. 6A-6C and the superhydrophobic surface of FIGS. 6A-6C.

FIGS. 8A-8B show images demonstrating the wetting behavior of a water droplet on one embodiment of a polydopamine modified superhydrophobic glass substrate.

FIG. 9 demonstrates the wetting behavior of a water droplet on one embodiment of a partially polydopamine modified superhydrophobic glass substrate.

FIG. 10 shows a graph demonstrating X-ray photoelectron spectroscopy (XPS) spectra from the unmodified area of the partially modified glass substrate of FIG. 9.

FIG. 11 shows a graph demonstrating the XPS spectra from the modified area of the partially modified glass substrate of FIG. 9.

FIGS. 12A-12D show optical microscopy images demonstrating one embodiment of an as-printed dopamine droplet on one embodiment of a superhydrophobic surface (FIG. 12A), one embodiment of polydopamine patterns printed on the surface (FIG. 12B) of FIG. 12A, and SEM images of the formed polydopamine patterns (FIGS. 12C and 12D) of FIG. 12B.

FIGS. 13A-13F shows optical microscopy images of as-printed dopamine droplets forming different patterns prior to polymerization (FIGS. 13A, 13C and 13E), the polydopamine patterns after polymerization (FIGS. 13B, 13D, and 13F), and XPS images demonstrating nitrogen mapping of the polydopamine micropattern of FIG. 13B (FIG. 13G). FIGS. 13A, 13C and 13E show optical microscopy images demonstrating various sized patterns generated by one embodiment of an as-printed dopamine droplet on one embodiment of a superhydrophobic surface having a 500 μm pattern (FIG. 13A), a 100 μm pattern (FIG. 13C), and a 50 μm (FIG. 13E). FIGS. 13B, 13D, and 13F, show optical microscopy images demonstrating polydopamine micropatterns on one embodiment of a superhydrophobic surface having a 500 μm pattern (FIG. 13B), a 100 μm pattern (FIG. 13D), and a 50 μm pattern (FIG. 13F).

FIGS. 14A-140 demonstrate nitrogen mapping of a micropatterned superhydrophobic surface.

FIG. 15 shows a photograph image demonstrating water droplets on one embodiment of a polydopamine pattern (500 μm features) printed on one embodiment of a superhydrophobic surface on a glass substrate after the glass substrate was immersed and then removed from water solution containing an aqueous red ink to facilitate observation of the water. A large water droplet (about 6 μL) was placed on the superhydrophobic surface after removal from the water solution for comparative purposes. The large water droplet was not observed to have wet the superhydrophobic surface.

FIGS. 16A-16C shows representative fluorescent microscopic images of one embodiment of a patterned superhydrophobic surface patterned with a square array of polydopamine after incubation in a solution containing fluorescein sodium (FIG. 16A), rhodamine B (FIG. 16B), or after incubation of with rhodamine B labeled polystyrene (PS) microspheres immobilized on the polydopamine patterned superhydrophobic surface (FIG. 16C). The patterned square (features) were about 500 μm (FIG. 16A) and about 50 μm (FIGS. 16B and 16C).

FIGS. 17A-17B demonstrate mixing of two liquid droplets containing methyl orange and acid before (FIG. 17A) and after (FIG. 17B) guided mixing along “Y” shaped microlines.

FIGS. 18A-18B shows representative optical microscopy images of one embodiment of as-printed superhydrophobic surface containing patterns, 500 μm (FIG. 18A) and 200 μm square features (FIG. 18B), generated using droplets of dopamine in a di-solvent solution (tris buffer (pH 8.5, 10 mM) and ethanol 1:1 (v/v)).

FIG. 19 demonstrates one embodiment of a system for collection of water from fog using a superhydrophobic substrate described herein.

FIG. 20 shows a graph demonstrating the water collection efficiency of different surface types.

FIGS. 21A-21E show images demonstrating water collection processes on a superhydrophilic surface. As demonstrated in FIGS. 21A-21E, on the superhydrophilic surface, water droplets spread over the surface and quickly forms a thin water film (arrow). All scale bars=500 μm.

FIGS. 22A-22E show images demonstrating water collection process on a superhydrophobic surface. As demonstrated in FIGS. 22A-22E, on the superhydrophobic surface, the droplets roll off the syperhydrophobic surface. All scale bars=500 μm.

FIGS. 23A-23E show images demonstrating water collection process on a superhydrophilic surface having 500 μm polydopamine micropatterns and a 1000 μm separation between the polydopamine micropatterns. As demonstrated in FIGS. 23A-23E, the time droplets spontaneously move and coalesce into the superhydrophilic polydopamine micropatterns (dashed circles and arrows). Some of the polydopamine micropatterns are outlined with black dashes. All scale bars=500 μm.

FIGS. 24A-24E show images demonstrating water collection process on a superhydrophobic surface having 200 μm polydopamine micropatterns and a 400 μm separation between the polydopamine micropatterns. As demonstrated in FIGS. 24A-24E, the time droplets spontaneously move and coalesce into the superhydrophilic polydopamine micropatterns (dashed circles and arrows). Some of the polydopamine micropatterns are outlined with black dashes. All scale bars=500 μm. Water films are shown by arrows.

FIGS. 25A-25E show images demonstrating water collection proves on a superhydrophobic surface having 200 μm polydopamine micropatterns and a 1000 μm separation between the polydopamine micropatterns. As demonstrated in FIGS. 25A-25E, the time droplets spontaneously move and coalesce into the superhydrophilic polydopamine micropatterns (dashed circles and arrows). Some of the polydopamine micropatterns are outlined with black dashes. All scale bars=500 μm. Water films are shown by arrows.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of molecular biology, microbiology, nanotechnology, organic chemistry, biochemistry, botany and the like, which are within the skill of the art. Such techniques are explained fully in the literature.

### Definitions

As used herein, “about,” “approximately,” and the like, when used in connection with a numerical variable, generally refers to the value of the variable and to all values of the variable that are within the experimental error (e.g., within the 95% confidence interval for the mean) or within .+−.10% of the indicated value, whichever is greater.

As used herein “contact angle” refers to the angle at which the liquid-vapor interface meets the solid-liquid interface of a fluid in contact with a surface. The contact angle provides an inverse measure of wettability.

As used herein, “low liquid contact angle” refers to a liquid contact angle of less than 90 degrees.

As used herein, “high liquid contact angle” refers to a liquid contact angle of greater than or equal to 90 degrees.

As used herein, “hydrophilic surface” refers to a surface that is wetable by water. These surfaces produce surface-liquid interactions that have low contact angles.

As used herein, “hydrophobic surface” refers to a surface that is not wetable by water. These surfaces produce surface-liquid interactions that have high contact angles.

The term “hydrophilic”, as used herein, refers to substances that have strongly polar groups that readily interact with water.

The term “hydrophobic”, as used herein, refers to substances that lack an affinity for water; tending to repel and not absorb water as well as not dissolve in or mix with water.

As used herein, “superhydrophobic surface” or “superhydrophobic substrate” refers to a surface wherein the surface-water interaction has a contact angle of greater than 150 degrees.

As used herein, “superhydrophilic surface” or superhydrophilic substrate” refers to a surface wherein the surface-water interaction has a contact angle of less than about 10 degrees.

As used herein, “perfect wetting surface” refers to a surface wherein the surface-liquid interaction has a contact angle of exactly 0 degrees.

As used herein, “perfectly non-wetting surface” refers to a surface wherein the surface-liquid interaction has a contact angle of exactly 180 degrees

As used herein, “wettability” refers to the degree of wetting by a liquid.

As used herein, “wetting” refers to the ability of a liquid to maintain contact with a surface, which results from intermolecular interactions when the liquid is brought into contact with the surface.

As used herein, “rough surface” refers to a surface that does not have perfect smoothness, rigidity, or chemical homogeneity.

As used herein, “homogenous wetting” or “Wenzel's wetting” refers to the condition where liquid fills the grooves of a surface. The Wenzel model describes homogenous wetting and defined by the following equation for the contact angle on a rough surface: cos θ*=r cos θ, where θ* is the apparent contact angle which corresponds to the stable equilibrium state, r is the roughness ratio, θ is the Young contact angle as defined for an ideal surface.

As used herein, “ideal solid surface” refers to a solid surface that is flat, rigid, perfectly smooth, chemically homogenous, and has zero contact angle hysteresis.

As used herein, “heterogeneous wetting” or “Cassie wetting” refers to the condition in which liquid does not fill all the grooves of a surface but fills none and sits on top of the grooves, leaving air pockets underneath the liquid (Cassie-Baxter Model), fills some of the grooves of the surface, but not all (Mushroom state formed during the transition from Cassie state to Wenzel State), or fills grooves underneath the liquid drop and grooves that are beyond the edge of the drop.

As used herein, “substrate” is used to describe a solid or semi-solid structure that is used as a support structure for a superhydrophobic or hydrophobic surface.

As used herein, “feature” is used to describe a non-superhydrophobic region on a superhydrophobic surface. Features can be any shape or size, including microdots, squares, or microlines.

As used herein, “catecholic compound” refers to a compound having a 1,2-dihdyroxybenxyene group and derivatives thereof.

### DISCUSSION

Superhydrophobic surfaces typically have low contact angle hysteresis along with a liquid contact angle of greater than about 150 degrees such that liquid droplets roll off the superhydrophobic surface easily when the surfaces are slightly tilted. The superhydrophobic surface can be patterned with hydrophilic or superhydrophilic areas and thus configured for various applications. Current superhydrophobic surfaces cannot be modified in a controlled manner because current solutions, including aqueous dopamine solutions, used to modify the superhydrophobic surface because they have a limited interaction between the solution or contents therein and the solid superhydrophobic surface. This limited interaction is the result of a low contact angle and high surface tension of the solution droplets on the superhydrophobic surface.

There are methods for creating such patterned surfaces, but most of them rely on an indirect, mask-based strategy. See e.g. Garrod, R. P, L. G. Harris, W. C. E. Schofield, J. McGettrick, L. J. Ward, D. O. H. Teare, J. P. S. Badyal. (2007) Langmuir, 23:689-693; Dorrer, C., and J. Ruhe. (2008) Lagmuir, 24: 6154-6158; Zahner, D. J. Abagat, F. Svec, J. M. J. Frechet, P. A. Levkin. (2011) Adv. Mater. 23:3030-3034; You, I., S. M. Kang, S. Lee, Y. O. Cho, J. B. Kim, S. B. Lee, Y. S. Na., H. Lee. (2012) Angew. Chem., Int. Ed. 51: 6126-6130; Manna, U., D. M. Lynn. (2013) ACS Appl. Mater. Interfaces. 5:7731-7736; Ishizaki, T., N Saito, and O., Takai. (2010) Langmuir. 26:8147-8154; Oliveria, S. M., W. Song, N. M. Alves, and J. F. Mano. (2011) Soft Matter. 7:8932-8941; and Geyer, F. L., E. Ueda, U. Liebel, N. Grau, and P. A. Levkin. (2011) Angew. Chem. Int. Ed. 50:8424-8427. In a mask-based strategy, a pre-designed mask preparation is utilized, which is followed by a subsequent pattern transfer, which is a multistep, indirect, and expensive process.

In the case of stable hydrophilic micro-sized patterns on superhydrophobic surfaces or substrates for practical applications, a direct method of depositing hydrophilic compounds and/or compositions that does not include a masking step is desirable for practical applications. However, such a direct method does not currently exist because 1) the ultralow surface energy of the superhydrophobic surface greatly decreases the adhesion between the hydrophilic compound/compositions and the superhydrophobic surface, which results in unstable deposition of the hydrophilic compound/composition, and 2) a superhydrophobic surface is a rough surface, which typically results in heterogeneous wetting when a liquid is brought into contact with the heterogeneous solid-air composite surface.

Due to the presence of discrete air pockets in the superhydrophobic surface, when liquid comes into contact with the surface, the liquid droplet only interacts with a small fraction of the solid surface. This is known as heterogeneous wetting or Cassie's wetting state. Cassie and Baxter. Trans. Faraday Soc. (1944). 40:546-551 and Wang and Jiang. Adv. Mater. (2007). 19:3423-3424. Both the limited interaction area and adhesion between the hydrophilic species in the aqueous droplets and the superhydrophobic substrate make direct patterning of the superhydrophobic surface impossible. Therefore, there exists a need for improved substrates, compositions and methods for creating patterns on superhydrophobic surfaces.

With that said, described herein are substrates, compositions, devices, systems and methods for direct patterning of superhydrophobic or hydrophobic surfaces and uses thereof. In some embodiments, the interaction strength (i.e. adhesion) between the hydrophilic compound/compositions in liquid droplets and the superhydrophobic or hydrophobic surface can be increased or enhanced and/or the contact area of the superhydrophobic or hydrophobic surface and the liquid droplet can be increased. In one embodiment, a composition containing at least a hydrophilic species, e.g. dopamine, can be deposited on a superhydrophobic or hydrophobic surface at one or more discrete locations. The composition having a hydrophilic species can be allowed to polymerize and adhere to the discrete location on the superhydrophobic or hydrophobic surface.

Also disclosed herein are compositions containing dopamine that can have a low surface tension and vapor pressure for use in patterning superhydrophobic surfaces. The methods and compositions described herein can result in a convenient and direct approach for the design and fabrication of patterned superhydrophobic surfaces, which can up a new avenue for engineering functionalized surfaces for advanced applications.

Other compositions, compounds, methods, features, and advantages of the present disclosure will be or become apparent to one having ordinary skill in the art upon examination of the following drawings, detailed description, and examples. It is intended that all such additional compositions, compounds, methods, features, and advantages be included within this description, and be within the scope of the present disclosure.

Micropatterned Superhydrophobic Surfaces and Substrates with Micropatterned Superhydrophobic Surfaces

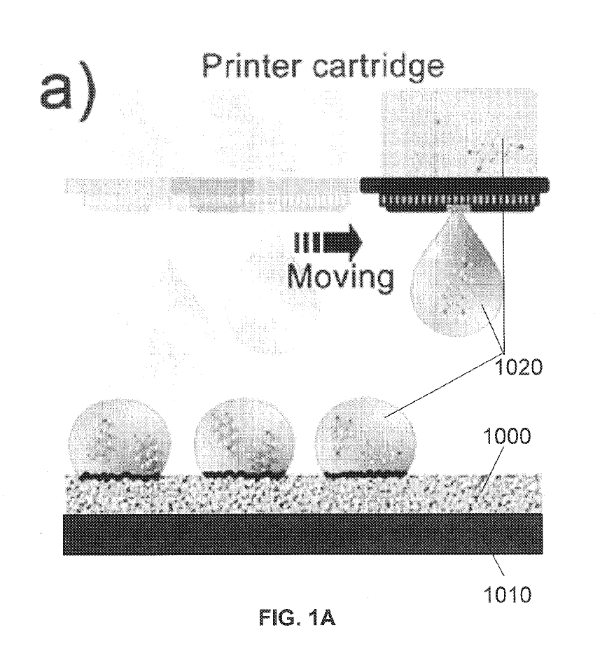

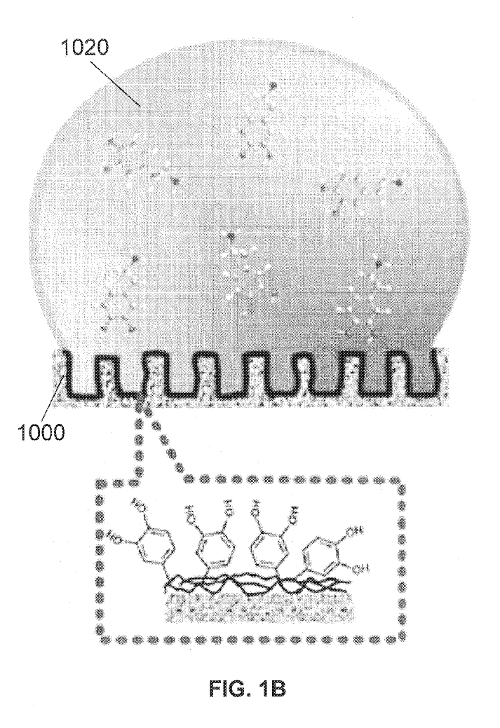

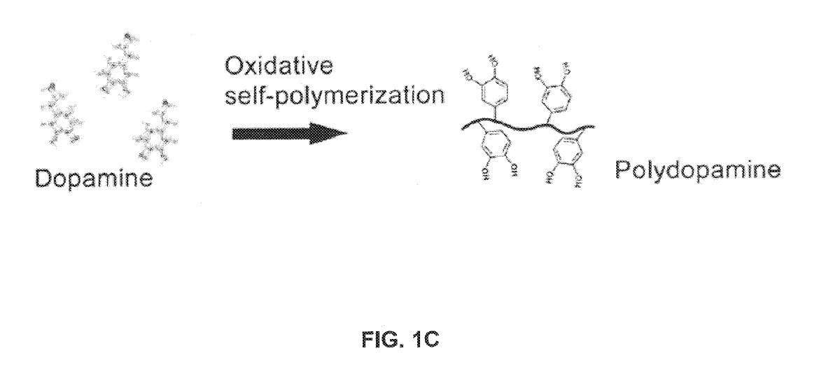

As shown, for example, in FIGS. 1A-1C described herein are superhydrophobic or hydrophobic (herein after superhydrophobic) surfaces 1000 that can be modified. The superhydrophobic or hydrophobic surface 1000 can be modified with hydrophilic or superhydrophilic (hereinafter superhydrophilic) regions. The superhydrophilic regions can be discrete from one another or can be joined together with one or more other superhydrophilic regions to form any desirable micropattern on the superhydrophobic surface. The superhydrophobic surface 1000 can be a solid. Suitable solids include, without limitation, glass, silicon wafers metal, metal oxide, plastic, or combinations thereof. The superhydrophobic surface 1000 can contain one or more air pockets within its three-dimensional structure. The superhydrophobic surface 1000 can have a rough texture.

The superhydrophobic surface 1000 can be modified to contain superhydrophilic regions. The superhydrophilic regions can form patterns (including micropatterns) on the superhydrophobic surface. The micropatterns can be made of one or more features, where each feature contains or is entirely composed of a superhydrophilic region. The features can have at least one dimension that is above about 5 nm. In some embodiments, the features can have at least one dimension that can be about 5 nm to about 5,000 nm.

Each feature can take on its own shape. While each feature can take any desired shape, in some embodiments the features can be microdots or microlines. The micropattern can therefore include any configuration of microdots or microlines. The features can be completely separate and discrete from one another and thus are separated from each other by sections of the superhydrophobic surface. In other embodiments, the at least two features can be connected to each other by being in direct contact with each other. In these embodiments, the superhydrophilic region of one feature is in direct contact with a point of another superhydrophilic region. In this way, the superhydrophobic surface can be configured for example, as an array of features, a connected network of features, or any combination thereof. The features can be separated and thus the pattern can be configured to have uniquely identifiable features.

Any two features can be separated from one another by any desired distance. In some embodiments, two or more features are separated from one another by a distance ranging from about 1 μm to about 5000 μm, about 20 μm to about 1000 μm, or about 200 μm to about 1000 μm. It will be appreciated by one of skill in the art that the desired distance of separation will depend on, inter alia, the composition of the superhydrophobic surface, the composition of the superhydrophilic features, and the application of the patterned superhydrophobic surface.

The superhydrophilic regions can be polymers containing a catecholic compound. Suitable catecholic compounds include, without limitation, dopamine, dopamine-quinone, alpha-methyldopamine, norepinephrine, 3,4-dihydroxyphenylalaninie (DOPA), L-DOPA, alpha-DOPA, droxidopa, 5-hydroxydopamine and combinations thereof. The polymers can be self-polymerizing polymers.

As shown in FIG. 1A, the superhydrophobic surface can be deposited or otherwise in direct contact with a substrate 1010. The substrate can be solid or semi-solid. Suitable solids include, without limitation, glass, silicon wafer, metal, metal oxide, plastic, or combination thereof. Suitable semi-solids include, without limitation an organic gel, a polymer gel, rubber, an elastomer, and combinations thereof.

The superhydrophobic surface can be any thickness. In some embodiments, the thickness of the superhydrophobic surface is about 5 μm or less. In one embodiment, the superhydrophobic surface is about 1.5 μm thick. The superhydrophobic surface can be rough in texture. The superhydrophobic surface can be porous. The superhydrophobic surface can be coated with a composition. In some embodiments the composition can be semifluorinated silane.

Compositions for Micropatterning Superhydrophobic Surfaces

As described herein the superhydrophobic surface 1000 can be modified to contain superhydrophilic regions. As shown in FIGS. 1A-1C, the superhydrophilic regions can be formed by depositing a suitable composition 1020 for modifying a superhydrophobic surface 1000 at one or more locations on the superhydrophobic surface 1000. The composition for modifying a superhydrophobic surface can have a low surface tension and low vapor pressure. The low surface tension can facilitate the transition from a Cassie's wetting state to a Wenzel's wetting state. The low vapor pressure can prolong self-polymerization of the hydrophilic species. The composition for modifying a superhydrophobic surface can be formulated such that composition droplets that exhibit Wenzel's wetting behavior (as opposed to exhibiting Cassie's wetting behavior) and have a high contact angle when in contact with the superhydrophobic surface. As shown in FIGS. 1A-1C, a droplet composition that exhibits Wenzel's wetting behavior can penetrate the rough surface structure of the superhydrophobic surface and displace the air pockets and thus can maximize the area of interaction between the deposited composition and the superhydrophobic surface.

The composition for modifying a superhydrophobic surface can contain a hydrophilic species. In some embodiments, the hydrophilic species can be a catecholic compound or derivative thereof. Suitable catecholic compounds include, but are not limited to dopamine, dopamine-quinone, alpha-methyldopamine, norepinephrine, 3,4-dihydroxyphenylalanine (DOPA), L-DOPA, alpha-DOPA, droxidopa, 5-hydroxydopamine, or combinations thereof. The catecholic compound can be any form of the catecholic compound or any variant thereof. In one embodiment, catecholic compound is synthetically derived. The concentration of the hydrophilic species within the composition for modifying a superhydrophobic surface can range from about 0.001 mg/mL to about 100 mg/mL. In some embodiments, the concentration of hydrophilic species compound is about 5 mg/mL.

In some embodiments, the composition for modifying the superhydrophobic or hydrophobic surface can also contain one or more solvents. The solvent can reduce the surface tension of the composition and reduce the vapor pressure of the composition. The solvent can be a water-miscible solvent. Suitable solvents include, but are not limited to water, ethanol, methanol, isopropanol, propanol, acetone, tetrahydrofuran, dimethysulfoxide, nitromethane, pyridine, ethylene glycol, diethylene glycol, glycerol, dimethylformamide, or combinations thereof.

In some embodiments, the composition for modifying a superhydrophobic surface can contain a suitable hydrophilic species and at least two solvents. In some of these embodiments, the hydrophilic species can be a catecholic compound. The catecholic compound can be is dopamine. In some embodiments, the first solvent can be water or a tris buffer solution and the second solvent can be ethanol. The ratio (v/v) of solvent 1: solvent 2 can range anywhere from 1:1 to 1:10 or from 10:1 to 1:1. In one embodiment, the ratio of solvent 1: solvent 2 is 1:1.

In other embodiments, the composition for modifying a superhydrophobic surface contains a suitable hydrophilic species and at least three solvents. The hydrophilic species can be a suitable catecholic compound and at least three solvents. In some of these embodiments, the catecholic compound can be dopamine. In some of these embodiments, solvent 1 can be water or a tris base solution, solvent 2 can be ethanol, and solvent 3 can be ethylene glycol. The ratio of sovent1:solvent 2:solvent 3 can range from about 1:1:1 to 1:10:1, about 1:1:1 to 1:1:10, about 1:1:1 to 10:1:1, about 1:1:1 to 10:10:1, about 1:1:1 to 10:1:10, about 1:1:1 to 10:10:1, about 1:1:1 to 1:10:10, and any ratios in between In embodiments containing a tri base solution, the tris base solution can contain tris base at a concentration ranging from about 0.1 mM to about 1000 mM. In some embodiments, the tris base solution can contain tris base at a concentration of about 10 mM. The pH of the tris base solution can range from about 7 to about 10. In one embodiment, the pH of the tris base solution can be about 8.5.

Methods of Making Micropatterned Superhydrophobic Surfaces

Also described herein are methods for modifying a superhydrophobic surface. The methods described herein include direct methods for modifying (including patterning) superhydrophobic surfaces with superhydrophilic regions. In some embodiments, the superhydrophobic surface can modified to contain superhydrophilic regions. As shown in FIGS. 1A-1C, the superhydrophobic surface can be modified by depositing a composition containing a hydrophilic species as described elsewhere herein on the superhydrophobic surface. The composition containing a hydrophilic species can be deposited in a controlled manner by a form of physical deposition, such that the superhydrophilic regions can be generated on the superhydrophobic surface in precise and desired locations. The composition containing a hydrophilic species can be deposited at any location or any number of locations on the superhydrophobic surface. Suitable physical deposition methods for depositing the composition containing a hydrophilic species on the superhydrophobic surface include, but are not limited to, inkjet printing, dip-pen lithography, microcontact printing, spraying, or combinations thereof. In some embodiments, the composition containing a hydrophilic species is deposited in separate and distinct locations on the superhydrophobic surface. Compositions containing a hydrophilic species can be deposited in a point-by-point manner or line-by-line manner.

Any suitable volume of the hydrophilic species containing composition can be deposited on the superhydrophobic surface. The individual droplet size can be any suitable size. One of ordinary skill in the art will appreciate that the volume of hydrophilic species containing composition and the droplet size will vary depending on, inter alia, the exact formulation of the composition, the composition of the superhydrophobic surface, the desired application of the superhydrophobic surface, the micropattern desired, and the physical deposition method used. In some embodiments the droplet volume can be as low as 1 picoliter. In other embodiments, the droplet size ranges from about 1 picoliter to about 5 mL.

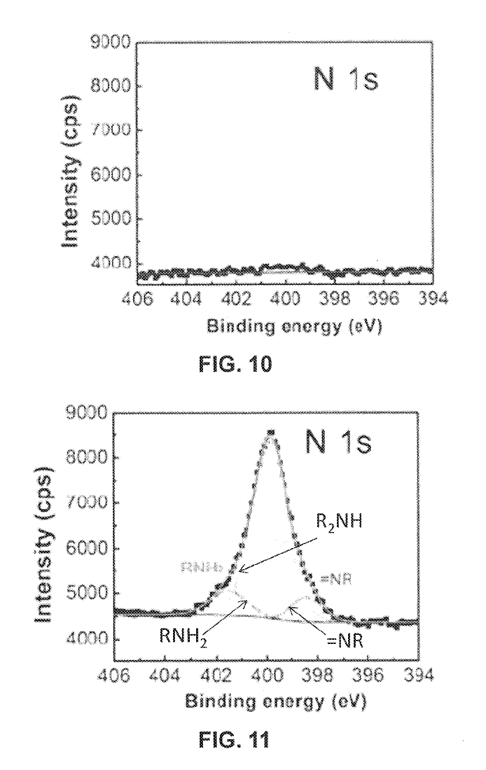

After depositing the composition containing a hydrophilic species on the superhydrophobic surface the superhydrophobic surface can be incubated until the catecholic compound contained within the solution is substantially polymerized. As used in this context, “substantially” refers to enough polymerization taking place so as to leave a polymerized hydrophilic species deposit on at least part of the superhydrophobic surface. In some embodiments, the composition containing a hydrophilic species self-polymerizes during incubation. The in situ self-polymerization of the hydrophilic species can result in stable superhydrophilic deposits on the superhydrophobic surface. An example of this is demonstrated in FIG. 10, which shows self-polymerization of dopamine. Incubation can take place in a sealed chamber. Incubation can occur at about 25° C. to about 100° C. In one embodiment, the incubation can take place at about 50° C. Incubation can take place for about 1 to about 72 hours. In one embodiment, the incubation can take place for about 36 hours.

In some embodiments, after polymerization, excess solution is removed by rinsing the superhydrophobic surface with ethanol. In further embodiments, the modified superhydrophobic surface is dried using a nitrogen flow. The methods described herein result in patterns of superhydrophilic regions on the superhydrophobic surface.

In embodiments where the superhydrophobic surface contains glass, the superhydrophobic surface can be prepared by dispersing silica nanoparticles are dispersed in a solvent to form a silica nanoparticle solution. In some embodiments, dispersion of silica can be followed by dissolving polystyrene (PS) granules in the silica nanoparticle solution to form a silica nanoparticle-PS granule mixture. The silica nanoparticle-PS granule mixture can be deposited on at least part of a substrate to form a silica nanoparticle-PS granule mixture coating on at least part of the substrate (e.g., a pattern). In some embodiments, the silica nanoparticles are dispersed in chloroform. In other embodiments, the silica nanoparticle-PS granule mixture can be deposited on the substrate via spin coating. The coated substrate can be heated and calcinated for an amount of time. Heating and calcination can remove organic material and to fuse the silica nanoparticles to one another. The coated substrate can be heated to about 600° C. or greater. In other embodiments, the coated substrate can be further coated with a semifluorinated silane. In one embodiment, the semifluorinated silane can be 1H,1H,2H,2H-perfloroctyltriethoxysilane (POTS). In an embodiment, the semifluorinated silane can be applied via a vapor deposition process. Coating the substrate with a semifluorinated silane can reduce the surface energy of the substrate.

Applications of Micropatterned Superhydrophobic Surfaces

Also described herein are apparatuses and devices that include a superhydrophobic surface or substrate having a superhydrophobic surface described elsewhere herein. The superhydrophobic surfaces and substrates having a superhydrophobic surface can be included in an apparatus, device, and/or system where such a superhydrophobic surface or substrate is desired. In some embodiments the superhydrophobic surface, substrate including a superhydrophobic surface, and apparatus or device including a superhydrophobic surface or substrate described herein, can be used to collect atmospheric water as well as used in cell arrays (including microarrays), soft lithography, cell culture, BioMEMS, tissue engineering, microfluidic devices, bioarrays, microconcentrator, surface enhanced raman spectroscopy, (i.e. an array containing biological elements) and other surface-tension confined microfluidics.

In some methods, atmospheric water can be collected by exposing a superhydrophobic surface having superhydrophilic features as described herein to the atmosphere (air). The method can include contacting the superhydrophobic surface having superhydrophilic features as described herein to atmospheric water present in the atmosphere. The atmospheric water that contacts the superhydrophobic surface having superhydrophilic features as described herein can then run or roll off of the superhydrophobic surface having superhydrophilic features as described herein and be collected. Removal of the water that contacts the superhydrophobic surface can be removed via gravity or any other mechanical or human driven mechanism or method.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

For the following Examples, SEM images were obtained on an FEI Quanta 600 SEM (FEI Company, Hilsboro, Oreg., USA). Contact angle and sliding angle measurements were performed with a commercial contact angle system of OCA 35 (DataPhysics, Germany) at ambient temperature using a 4 μL droplet as the indicator. The optical and fluorescent microscopic measurements were performed by a multipurpose zoom AZ100-M system (Nikon, Japan). X-ray photoelectron spectroscopy (XPS) measurements were recorded on AXIS-NOVA instrument (Kratos Analytical Ltd, UK) using a monochromatic A1 Ka x-ray source (1486.6 eV). Survey spectra were collected using a pass energy of 160 eV and a step size of 1 eV. Pass energy of 20 eV and a step size of 0.1 eV were used for the high resolution spectra. The XPS analysis was performed with small spot analysis size of 110 μm×110 μm at a base pressure of <1×10⁻⁹ Pa.

The lateral distribution of the elements on the surface was mapped using imaging-XPS. Charge neutralization was required for all samples. Binding energies were referenced to the C1s binding energy of adventitious carbon contamination, which was taken to be 285.0 eV for superhydrophobic surface, while the binding energy scale was referenced to the sp2 carbon component from polydopamine at 284.4 eV in the C 1s spectrum. The data were analyzed with commercially available software, CASAXPS. The individual peaks were fitted by a Gaussian (70%)-Lorentzian (30%) (GL30) function after Shirley type background subtraction. Digital images and videos were captured by using a Nikon camera (Nikon COOLPIX P100). Inkjet printing was carried out using a piezoelectric-based inkjet printer (Dimatix Materials Printer DMP-2800 (Fujifilm Dimatix)). The Dimatix Materials Printer cartridge used generated droplets about 10 picoliters in volume.

Materials used in the following Examples are as follows, unless stated otherwise in the Examples: Dopamine hydrochloride, polystyrene granules (PS, MW about 350,000), 1H,1H,2H,2H-perfluorooctyltriethoxysilane (POTS), poly(ethyleneimine), (PEI, MW about 750,000), fluorescein sodium, rhodamine B, rhodamine B isothiocyanate, methyl orange, Trizma® base, ethanol, ethylene glycol, chloroform, hydrochloric acid (HCl), and NaOH, all of which were from Sigma-Aldrich, hydrophobic PDMS-modified silica nanoparticles (diameter about 14 nm) and polystyrene (PS) microsphere suspension (diameter about 10 μm, about 2.5 wt %), which were purchased from Alfa Aesar. All of these chemicals were used as received, unless otherwise noted in the Examples below. Deionized (DI) water was used in all experiments and was prepared using a Milli-Q® system (Millipore).

### Example 1: Preparation of a Superhydrophobic Surface

A superhydrophobic surface was prepared on a glass slide substrate by depositing silica nanoparticles to obtain a rough surface. This was followed by a fluorination process to decrease the surface energy. Briefly, about 1.0 g of silica nanoparticles was dispersed in 30 mL of chloroform. Then, about 1.0 g of polystyrene (PS) granules (MW about 350,000) was dissolved in the silica nanoparticle/chloroform dispersion by continuous stirring for about 1 hour. The resulting mixture was then spin coated on pre-cleaned glass slides at about 1500 rpm for about 60 seconds. The coated glass slides were then transferred into an oven and calcinated for about 2 hours at about 600° C. to remove the organic component and fuse the silica nanoparticles together. To reduce the surface energy, the calcinated glass slides were coated with a semifluorinated silane of 1H,1H,2H,2H-perfluorooctyltriethoxysilane (POTS) by chemical vapor deposition to obtain superhydrophobic surfaces. See e.g. Lafuma, A. and D. Quere. (2003) Nat. Mater. 2:457-460.

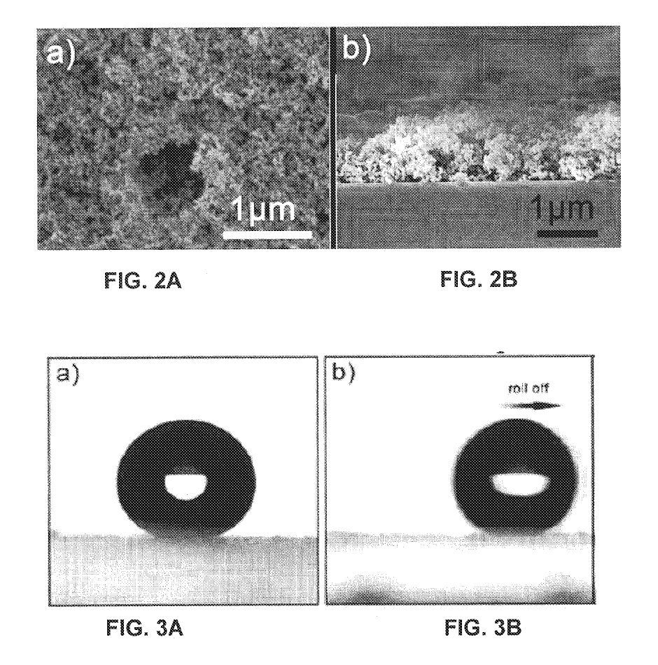

Representative SEM images of the prepared superhydrophobic surface on the glass slides are shown in FIGS. 2A-2B. Due to the deposition of silica nanoparticles on the surface, a rough surface with a highly porous surface structure was obtained on the glass slide substrate (FIGS. 2A and 2B). As shown in the cross sectional view in FIG. 2B, the thickness of the silica-nanoparticle coating was about 1.5 μm.

### Example 2: Wetting Behaviors of Liquids Containing Ethanol on a Prepared Superhydrophobic Surface

As shown in FIGS. 3A-3B and Table 1, the prepared superhydrophobic surface prepared in Example 1 exhibited a water contact angle of about 157 degrees (FIG. 3A) and a sliding angle of less than about 1 degree (FIG. 3B). This indicated that the prepared superhydrophobic surface exhibited a typical Cassie's wetting behavior.

To investigate the wetting behavior of liquids containing a low surface-tension solvent, ethanol, which is a water-miscible and low surface-tension solvent (surface tension of about 22 mN m⁻¹), was first added into water at different rations (Table 1). Then, the wetting behaviors of various liquid mixtures having different fractions of ethanol on the prepared superhydrophobic surface were investigated. The results are shown in Table 1. In general, as the fraction of ethanol in the mixture increased, the contact angle of the liquid on the surface decreased.

TABLE 1

| | | Water:Ethanol | Water:Ethanol | Water:Ethanol | Water:Ethanol | |
|---|---|---|---|---|---|---|
| | Water | (3:1 v/v) | (2:1 v/v) | (1:1 v/v) | (1:2 v/v) | Ethanol |
| Contact | 157 | 155 | 146 | 134 | 15 | 0 |
| angle | | | | | | |
| (degrees) | | | | | | |
| Sliding | <1 | 3 | 7 | NA^{(a)} | NA^{(a)} | NA^{(a)} |
| angle | | | | | | |
| (degrees) | | | | | | |

^{(a)}Liquid droplets were pinned on the surfaces with high adhesion and no sliding behaviors were observed during tilting of the substrates

When the droplet of water and ethanol had a ratio of 1:1 water to ethanol (v/v), the contact angle was about 134 degrees. This droplet was also firmly pinned on the prepared superhydrophobic surface. No detachment was observed even when the prepared superhydrophobic surface on the glass substrate was reversed into an upside down position. This suggested that the droplet having a 1:1 ratio of water to ethanol (v/v) was acting according to Wenzel's model of wetting. These results demonstrate that by varying the fraction of low-surface tension solvent (i.e. ethanol) in water, a transition of the wetting behavior from Cassie's to Wenzel's state can be achieved for a liquid droplet on a superhydrophobic surface.

### Example 3: Wetting Behaviors of Liquids Containing Ethylene Glycol on a Prepared Superhydrophobic Surface

To lower the vapor pressure, and thus decreasing the rate of evaporation of microdroplets containing a dopamine solution from a superhydrophobic surface, ethylene glycol was investigated as a solvent for the dopamine microdroplet composition. Ethylene glycol has a high boiling point of about 197.3° C., a low vapor pressure (0.06 mmHg at room temperature), and a low surface tension (47 mN m⁻¹). Ultimately, a water-ethanol-ethylene glycol tri-solvent composition with a volume ration of 1:1:1 water to ethanol to ethylene glycol (v/v) was chosen as the solvent for preparation of a dopamine solution for directly micropatterning a superhydrophobic surface.

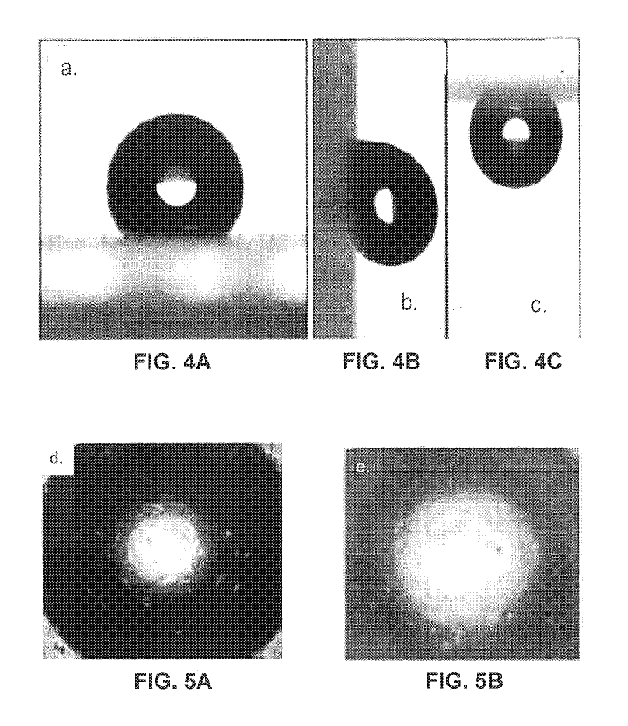

FIGS. 4A-4C shows optical images of tri-solvent liquid droplets and water droplets on prepared superhydrophobic surface. As demonstrated in FIG. 4A, the tri-solvent droplet in the absence of dopamine had a contact angel of about 130 degrees and high adhesion to the superhydrophobic surface prepared according to Example 1. As demonstrated in FIGS. 4B and 4C, even when the glass substrate with the superhydrophobic surface was perpendicular to the horizontal plane (FIG. 4B) and inverted (FIG. 4C), the droplet remained firmly adhered to the superhydrophobic surface. This suggests that the tri-solvent droplet in the absence of dopamine was acting according to Wenzel's wetting behavior.

To demonstrate the Wenzel's wetting behavior of the tri-solvent droplet on the superhydrophobic surface, the tri-solvent droplet was episcopically illuminated and optically imaged from above through a microscope. Results are shown in FIGS. 5A and 5B. This imaging technique allows for observation of the interface between the liquid droplet and the superhydrophobic surface. Specifically, air pockets in the nanostructures of the surface underneath a liquid droplet can be observed due to the light reflection difference between the air-liquid interface and the liquid-solid interface. In the images, the high light reflection (bright region) observed under the liquid droplets is the result of the interface between the liquid droplet and the air. The dark region is the result of the low reflection at the liquid-solid interface. As shown in FIG. 5A, for the tri-solvent droplet of water, ethanol, and ethylene glycol, only sparse bright regions were observed at the interface between the liquid droplet and the superhydrophobic surface, suggesting that most of the air pockets were displaced from the interface and sufficient and effective contact to adhere the droplet to the surface was achieved. In contrast, as shown in FIG. 5B, a pure water droplet on the same superhydrophobic surface, the bright region was observed to occupy the majority of the contacting area, demonstrating the continuous air plastron under the water droplet and confirm its Cassie's wetting state.

### Example 4: Wetting Behaviors of Tri-Solvent Liquid Droplets Containing Dopamine on a Prepared Superhydrophobic Surface

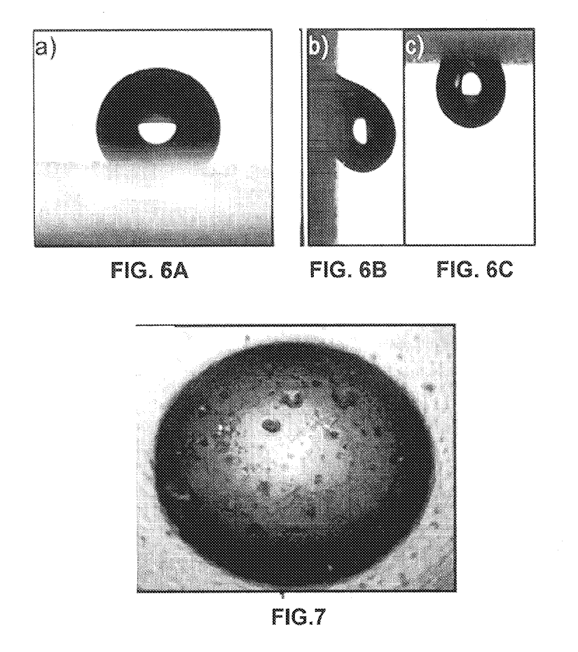

Dopamine was added to a tri-solvent solution to a final concentration of 5 mg/mL. In this Example, the tri-solvent solution contained tris buffer solution (10 mM, pH 8.5), ethanol, and ethylene glycol at a ratio of 1:1:1 (v/v/v). Droplets were contacted with a superhydrophobic surface prepared as described in Example 1. Behavior of the droplets was examined optically as described in Example 3. Representative images are shown in FIGS. 6A-6C, which demonstrates shapes of the dopamine solution droplets prepared in the tri-solvent system pm superhydrophobic surfaces with different tilting angles. At a tilting angle of 0 degrees, the contact angle was about 128 degrees (FIG. 6A). FIGS. 6B and 6C demonstrate the behavior of the droplet at tilting angles of 90 degrees (perpendicular to the horizontal axis) (FIG. 6B) and 180 degrees (inverted) (FIG. 6C). FIG. 7 shows an optical image where the droplet was episcopically illuminated and optically imaged from above through a microscope demonstrating the interface between the dopamine droplet and the superhydrophobic surface. The dopamine-tri-solvent droplet demonstrated a similar wetting behavior to the tri-solvent droplet discussed in Example 3 (FIG. 5A). In other words, the dopamine-tri-solvent droplet appeared to exhibit Wenzel's wetting behavior. As such, these results suggest that the addition of dopamine negligibly influenced the surface tension of the tri-solvent system.

### Example 5: Effect of Surface Modification with Polydopamine in a Tri-Solvent System

The superhydrophobic substrate prepared as in Example 1 was immersed into the bulk dopamine solution prepared by the tri-solvent system and incubated for a sufficient amount of time for dopamine to polymerize to form polydopamine. Briefly, a slide of the prepared superhydrophobic glass substrate was partially immersed in a freshly prepared solution of dopamine (5.0 mg/mL) in tris buffer (10 mM, pH 8.5), ethanol, and ethylene glycol at a ratio of 1:1:1 (v/v/v) and then kept in a sealed chamber at 50° C. for about 36 hours to allow dopamine to polymerize via oxidative polymerization. After polymerization, the glass slide substrate with the modified superhydrophobic surface was removed from the sealed chamber and washed with copious amounts of ethanol and dried with nitrogen flow.

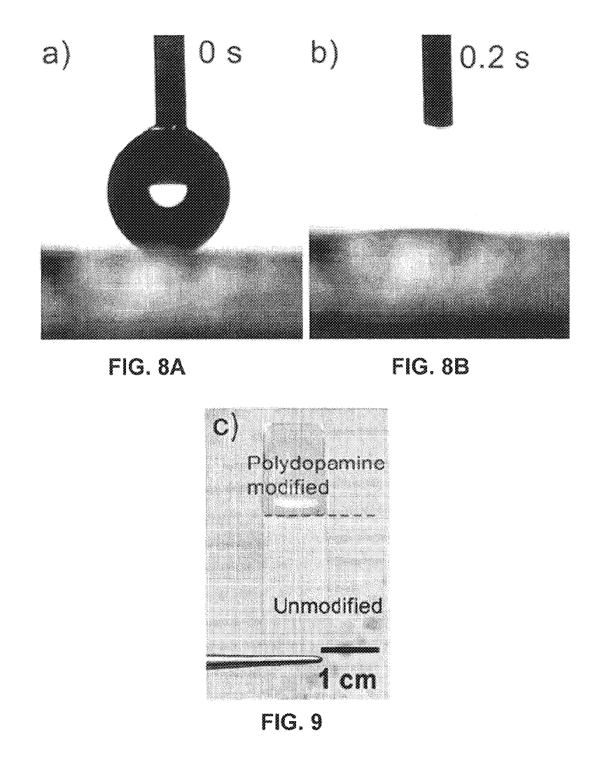

After the polydopamine coating was formed on the superhydrophobic surface the treated surface turned superhydrophilic. The superhydrophilic treated surface had a water contact angle of about 0 degrees. As demonstrated by the snapshots from a contact angle measurement video showing the wetting behavior of a water droplet on the polydopamine modified superhydrophobic surface (FIGS. 8A and 8B), the water droplet completely spread out over the surface upon contact. Complete spreading of the liquid droplet (FIG. 8B) was observed in less than 0.2 seconds. FIG. 9 shows a photo of a polydopamine partially modified superhydrophobic glass slide and demonstrates the water-repelling characteristic of unmodified (lower region of the slide). As demonstrated in FIG. 9, water wetted the polydopamine modified region (upper region of the glass slide), but could not penetrate the unmodified region of the glass slide.

The formation of the polydopamine coating was also confirmed by X-ray photoelectron spectroscopy (XPS) measurement (FIGS. 10 and 11). High-resolution XPS spectra of N 1s recorded from the unmodified area (FIG. 10) and the polydopamine modified area (FIG. 11) of the partially modified superhydrophobic surface on a glass substrate. The N 1s signal from the unmodified area was almost absent. In contrast, the N 1s signal appeared for the polydopamine modified area. The N 1s peak was fitted with three components located at 401.5, 399.9, and 398.4 eV assigned to primary (R—NH₂), secondary (R—NH—R, and tertiary (—N—R) amine functionalities, respectively. As shown in FIG. 6E, the dominant secondary amine component (R—NH—R) situated at 399.9 eV suggests formation of polydopamine as this pattern is characteristic of polydopamine (See e.g. Zangmeister, R. A., T. A. Morris, and M. J. Tarlov (2013) Langmuir. 29:8619-8628). These results suggest the successful modification of the superhydrophobic surface by polydopamine.

### Example 6: Ink-Jet Printing Using a Tri-Solvent Dopamine Solution

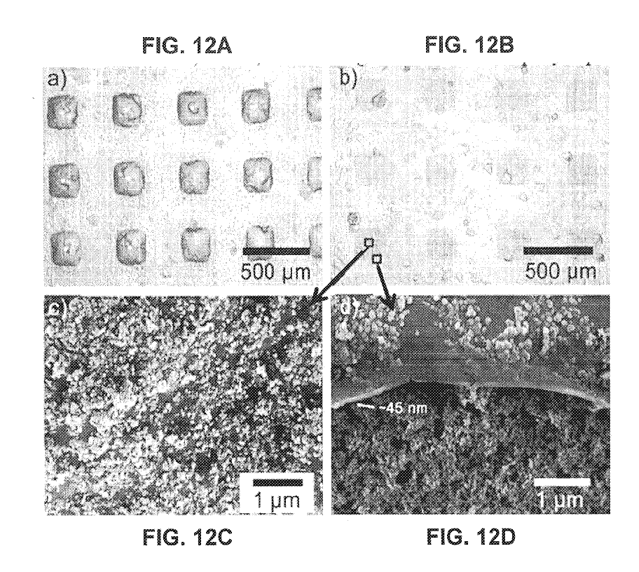

Based on the demonstrated Wenzel's wetting state and formation of polydopamine on the superhydrophobic surface, the tri-solvent dopamine solution was then used in an inkjet printing system. More specifically, the freshly prepared dopamine solution (See e.g. Example 5) was filled in a printer cartridge and then printed on the superhydrophobic surface in picoliter-volume droplets. FIG. 12A shows an optical microscopic image of an as-printed square array of the dopamine solution with a feature size of about 200 μm. Upon printing, the dopamine droplets firmly adhered to the pre-designated locations on the superhydrophobic substrate without detachment, even when the surface was tilted to about 90 degrees (perpendicular to horizontal) or about 180 degrees (inverted). The superhydrophobic surface with the printed dopamine solution droplets was stored in a sealed chamber at about 50° C. for about 36 hours, allowing oxidative self-polymerization of dopamine to occur. During printing, the print cartridge was placed about 300 μm above the superhydrophobic surface. The modified superhydrophobic surface was rinsed with copious ethanol to remove residual solvents and unattached polydopamine before drying with a nitrogen flow as described in Example 5.

As demonstrated in the optical microscope image of in FIG. 12B, after the treatments described above, the polydopamine pattern of the square array on the surface was observed and the size of polydopamine pattern (about 200 μm) was the same as that of the printed precursor dopamine droplet of FIG. 12A. The as-prepared polydopamine pattern on the super hydrophobic surface is stable and can withstand washing with strong organic solvents (e.g. acetone and ethanol). FIGS. 12C and 12D show SEM images of the central and edge regions of the polydopamine pattern, respectively. It was observed that the formed polydopamine coating uniformly covered the superhydrophobic surface, with nanoparticle sizes ranging from about 50 mm to about 100 mm. These nanoparticles were silica nanoparticles coated with polydopamine and the polydopamine nanoparticles formed during the oxidative polymerization process. The nanoparticles on the patterned area increased the roughness of the surface, and thus likely enhanced the hydrophilicity of the polydopamine patterns, which likely lead to syperhydrophilicity (FIGS. 8A-8B and 9-11). The thickness of the polydopamine coating is about 45 nm, as can be observed in the edge pattern shown in FIG. 12D.

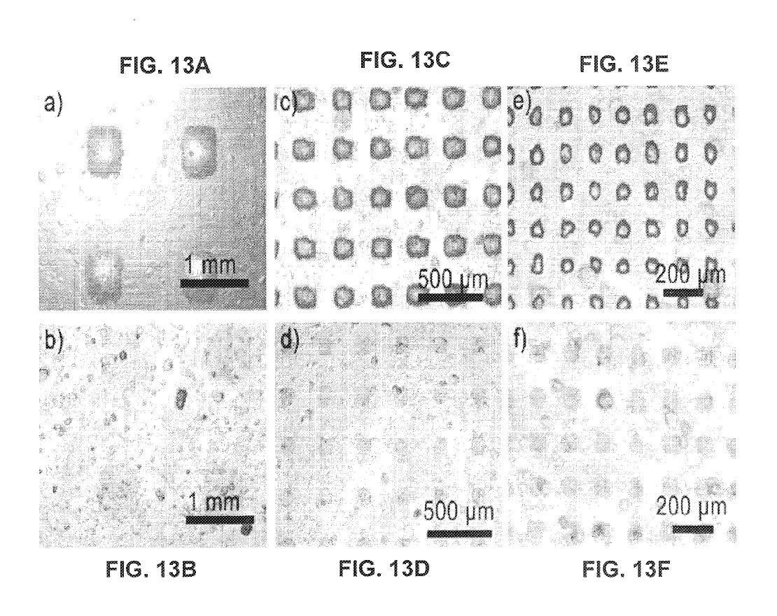

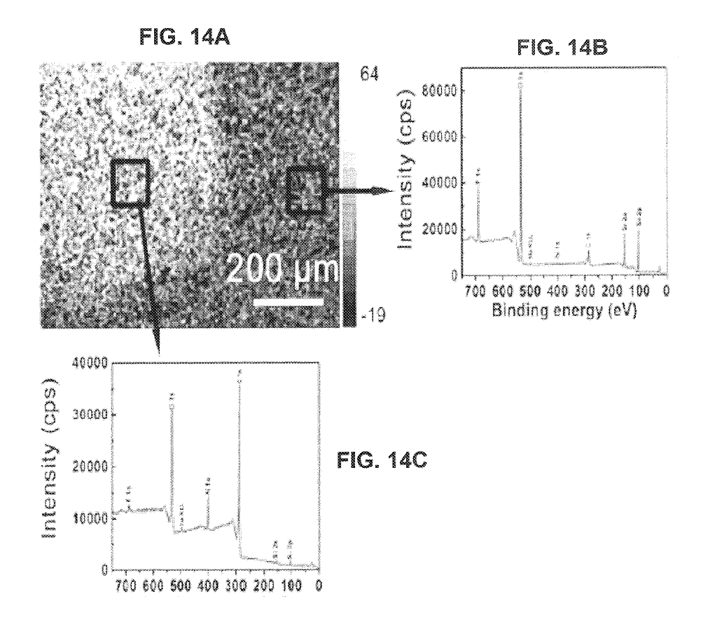

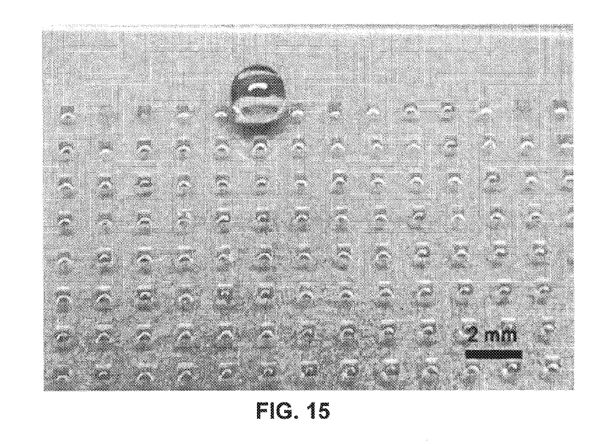

Using inkjet printing methods, micropatterns of polydopamine with various feature sizes, even down to about 50 μm can be readily prepared as shown in FIGS. 13A-13F. FIGS. 13A, 13C, and 13E show representative optical microscope photographs of the as-printed dopamine droplet on the superhydrophobic surface in a 500 μm pattern (FIG. 13A), a 100 μm pattern (FIG. 13C), a 50 μm pattern (FIG. 13E). FIGS. 13B, 13D, and 13F show representative optical microscope photographs of the formed polydopamine patterns on the surface after oxidative polymerization of dopamine in a 500 μm pattern (FIG. 13B), a 100 μm pattern (FIG. 13D), a 50 μm pattern (FIG. 13F). FIGS. 14A-140 demonstrates nitrogen mapping of the 500 μm polydopamine micropattern on the superhydrophobic surface. The XPS image was corrected for inelastic background. The image of FIG. 14A demonstrates the polydopamine pattern according to the presence of the nitrogen signal. Survey spectra (FIGS. 14B and 14C) with small spot analysis were recorded in two selected areas (each 110 μm×110 μm) of the polydopamine modified area and the unmodified area. For the unmodified area, Si, C, O, and F were observed to be associated with the superhydrophobic surface. For the polydopamine coated area, an additional nitrogen element was observed. This occurred along with a decrease in the F and Si signal. The results demonstrated in FIGS. 13A-13F and 14A-14C are comparable to what existing mask-based methods can produce in terms of preparation of patterned wettability. To verify patterning of the superhydrophobic surface, the surface/substrate with polydopamine micropatterns was immersed in water and then withdrawn. It was observed that there were tiny, discrete water droplets adhering to the polydopamine modified patches which are isolated be the non-modified regions. These results are demonstrated in FIG. 15.

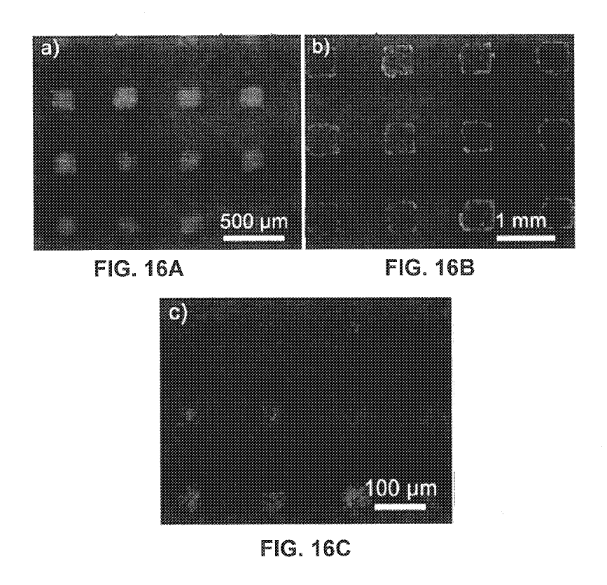

To aid in observing the deposition of the polydopamine, fluorescein sodium was added to water and the surface/substrate was submersed in the water. Immediately after withdrawing the surface/substrate from the water containing fluorescein images of the surface/substrate was taken using fluorescent microscopy. As shown in FIG. 16A, significant green fluorescence was observed only in the polydopamine patterned area. This observation suggested that the water droplets labeled with fluorescein sodium attached only on the hydrophilic areas, which further suggested that patterning of the superhydrophobic surface was achieved.

By using the superhydrophilic patterns on the superhydrophobic surface as a template, hydrophilic molecules and microspheres can be selectively immobilized on a pre-designated area of the polydopamine patterns. FIGS. 16B and 16C show the representative images from fluorescent microscopy of rhodamine B molecule immobilized on the patterned superhydrophobic surface (FIG. 16B) and rhodamine B-labeled polystyrene (PS microspheres (diameter less than about 10 μmm) that were selectively immobilized on the patterned superhydrophobic surface (FIG. 16C).

Rhodamine B was immobilized on the patterned superhydrophobic surface by immersing the patterned superhydrophobic surface/substrate in an aqueous solution of rhodamine B (about 10 μm) for about 30 minutes. After incubation, the superhydrophobic surface/substrate was removed from the aqueous solution and dried with nitrogen flow. As shown in FIG. 16B, rhodamine B was selectively immobilized on the hydrophilic polydopamine area printed on the superhydrophobic surface.

Rhodamine B labeled PS microspheres were prepared as follows. 0.5 mL of a PS microsphere suspension (2.5 wt %) was added to 1.0 mL of PEI solution (1.0 mg/mL) and the mixture was incubated under slight shaking for about 1 hour. After incubation, the PS microspheres were separated by centrifugation and washed three times with about 1.5 mL of water. The PEI modified PS microspheres were then dispersed well in about 1.5 mL. Then, about 0.5 mL of the above PEI modified PS microsphere dispersion was mixed with about 0.5 mL of water and then about 50 μL of a rhodamine B isothiocyanate methanol solution (2 mg/mL) was added to the mixture. After addition of the rhodamine B solution, the mixture was incubated with slight shaking for about 48 hours. After incubation the fluorescent rhodamine B PS microspheres were washed with water and finally dispersed in water to a final concentration of about 2.0 mg/mL.

Droplets of rhodamine B labeled PS microspheres were placed on the polydopamine patterned superhydrophobic surface. After letting the droplets incubate on the polydopamine patterned superhydrophobic surface for several minutes, the droplets were removed from the surface using a micropipette. It was observed that the rhodamine B labeled PS microspheres in the aqueous suspension were selectively absorbed on the hydrophilic patterns (FIG. 16C).

### Example 7: Inkjet Printing for Direct Micropatterning Using a Di-Solvent Dopamine Composition

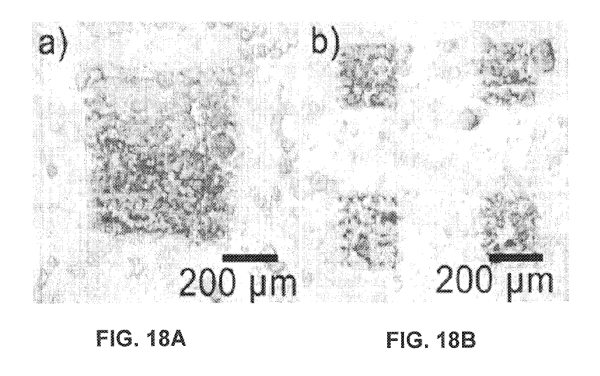

The dopamine droplet composition was prepared by adding dopamine to a di-solvent solution containing water and ethanol (ratio of 1:1 v/v). The final solution was then used in an inkjet printing system as described in Example 6. This solution failed to produce any observable liquid droplets on the printed area of the superhydrophobic substrate. Only some discretely distributed dry powders, as shown in FIGS. 18A-18B, were observed. These results are likely due to the high vapor pressure of water and ethanol, which evaporated quickly during and after printing, leaving behind only solutes on the surface. Rapid evaporation of the solvents can lead to an inability to form a uniform polydopamine coating on the superhydrophobic surface. This demonstrates a role for ethylene glycol in the dopamine solution.

### Example 8: Inkjet Printing for Patterning of a Superhydrophobic Surface with Guiding Tracks to Control Liquid Droplet Movement

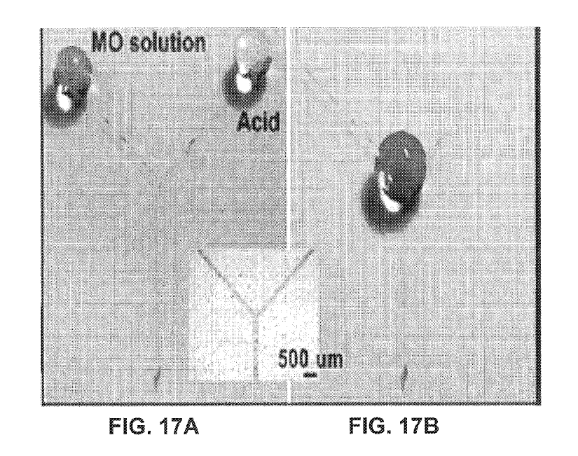

As shown in FIGS. 17A-17B The dopamine droplet composition was printed (See Example 6) on the superhydrophobic surface in a “Y” microline pattern. The microline had a width of about 200 μm. It was observed that the microline could guide the movement of the liquid droplets on the superhydrophobic substrate. It was observed that the liquid droplets contacting the microlines adhered to the microline track and were moved by external forces (e.g. micropipette tip) only along the microlines. This was likely due to the hydrophilicity of the microlines. With this “Y” shaped microline track, two water droplets, methyl orange (“MO”) (8 μL, 0.1 mg/mL MO) and acid (8 μL, pH 2.0) could be moved along the designed tracks and mixed together where the two upper arms of the “Y” track met (FIG. 17B). Upon mixing, the color of the MO droplet changed from yellow to red because of the excess proton coming from the acid droplet.

### Example 9: Fog-Harvesting Using a Polydopamine Micropatterned Superhydrophobic Surface

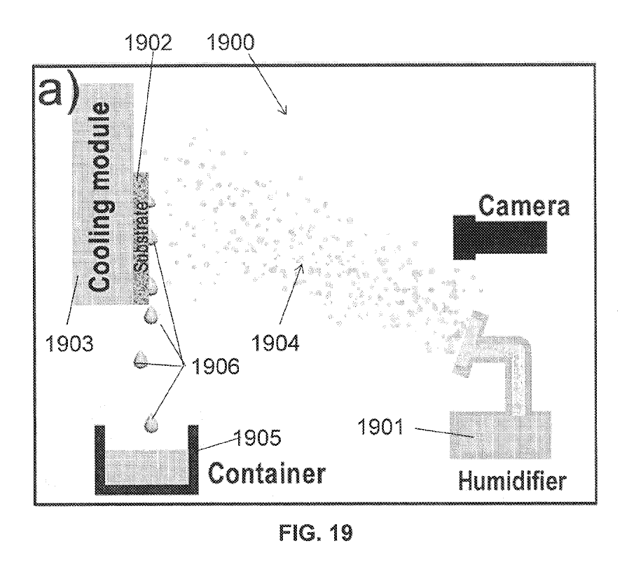

Superhydrophobic surfaces having a micropattern of polydopamine features were prepared using inkjet printing as described elsewhere herein. These polydopamine micropatterned superhydrophobic surfaces were then used to investigate their fog-harvesting performance. FIG. 19 shows a schematic of the experimental setup for the fog-harvesting system 1900 that includes a test surface. A simulated fog flow 1904 was generated by a commercial humidifier 1901 and captured by the test surface 1902 that was mounted on a cooling module 1903. The cooling module 1903 maintained the test surface 1902 at a constant temperature of about 4° C., which was sufficiently lower than the dew point. Water that condensed 1906 on the test surface 1902 was drained by gravity into a collection container 1905 that was positioned below the test surface 1902. The test surfaces were: 1) non-patterned superhydrophilic glass surface with a water contact angle of less than 5°; 2) non-patterned superhydrophobic glass surface; 3) polydopamine patterned superhydrophobic surface with 500 μm polydopamine regions separated by 1000 μm; 4) polydopamine patterned superhydrophobic surface with 200 μm polydopamine regions separated by 400 μm; and 5 polydopamine patterned superhydrophobic surface with 200 μm polydopamine regions separated by 1000 μm.

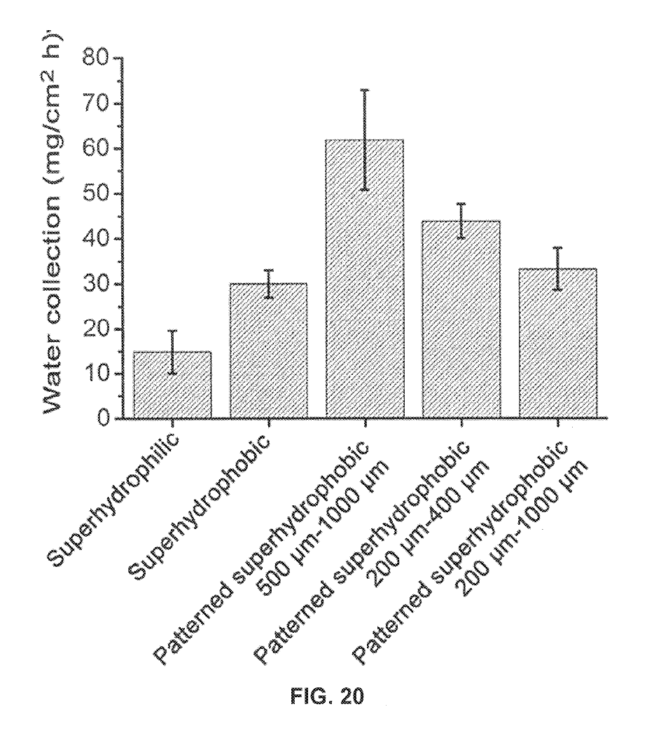

FIG. 20 demonstrates the collection efficiencies of the 5 test surfaces. The superhydrophilic surface had a water collection efficiency of about 14. The superhydrophilic surface had a water collection efficiency of about 14.9 mg cm² h⁻¹, the lowest among the five tested substrates, whereas the uniformly superhydrophobic surface achieved a water collection efficiency of about 30.0 mg cm² h⁻¹. In comparison, enhanced water collection efficiency was observed on all three polydopamine micropatterned superhydrophobic surfaces, ranging from about 33.2 to 61.8 mg cm² h⁻¹. The micropatterned substrate with a pattern size of about 500 μm and a separation distance of about 1000 μm exhibited the highest efficiency of about 61.8 mg cm² h⁻¹, about four times that of the superhydrophilic surface.

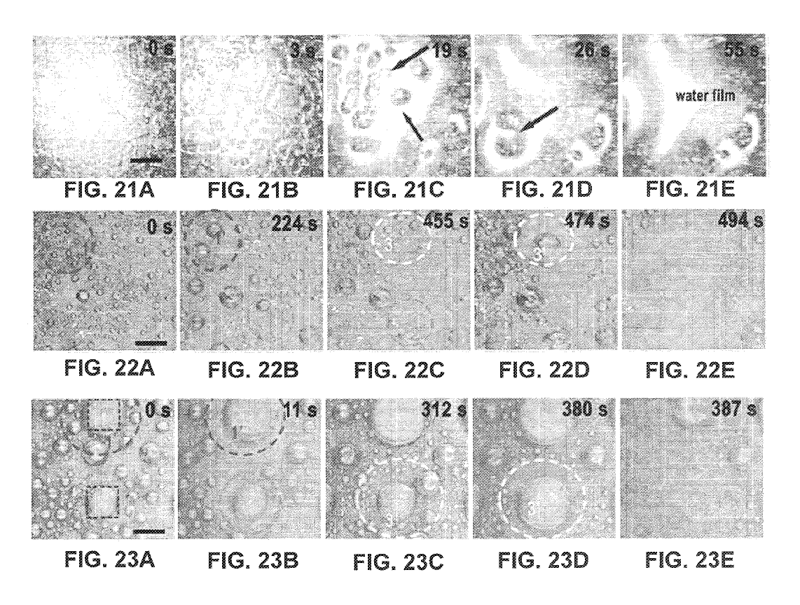

To better understand the fog-harvesting behavior of the test surfaces, optical microscopic imaging was used to record the water collection processes on these surfaces. FIGS. 21A-21E show that, for the uniformly superhydrophilic surface, the water droplets, once condensed, immediately spread out over the surface and a thin water □lm formed within a short period of time. This is known as film-wise condensation. In contrast, FIGS. 22A-22E show that tiny spherical water droplets were formed and captured on the uniformly superhydrophobic surface and that these small droplets gradually merged into larger droplets. As the size of these droplets increased beyond a certain threshold, the droplets became unstable and rolled off the superhydrophobic surface as a result of gravity. Compared with the film-wise condensation on the superhydrophilic surface, the drop-wise condensation of the superhydrophobic surface can allow for more efficient heat transfer, because the water film has a higher interfacial thermal resistance. In addition, the self-clearing of the droplets from the superhydrophobic surfaces can allow for the continuous nucleation and growth of new droplets, which can lead to enhanced water collection.

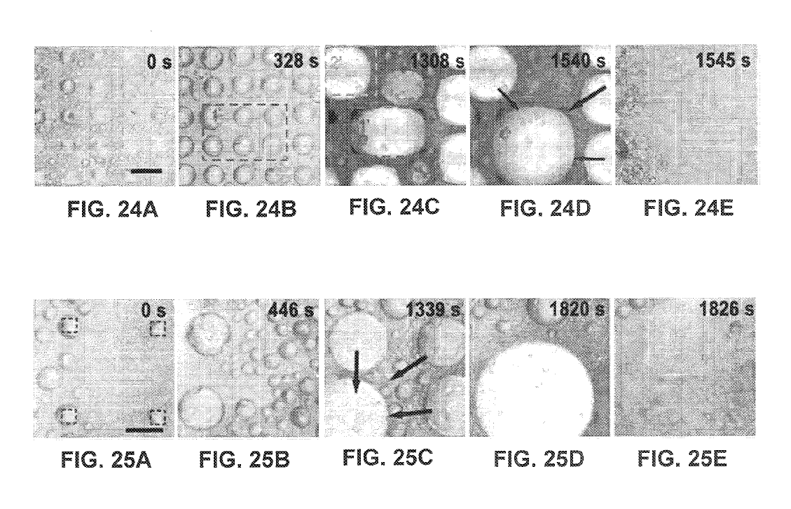

FIGS. 23A-23E, 24A-24E, and 25A-25E show the condensation and capture of tiny water droplets on the superhydrophobic regions of the micropatterned surfaces. However, once formed, these droplets were observed to preferentially move toward the polydopamine-modified superhydrophilic regions, driven by the wettability differences, and subsequently were observed to coalesce into bigger droplets in these regions. As the droplets in the superhydrophilic regions grew beyond a certain threshold, they were removed from the surface by gravity.

From a water collection point of view, a desirable surface promotes both droplet nucleation and droplet removal simultaneously, seemingly contradictory processes. Thus there should be a well-selected tipping point at which these two properties are integrated in one surface because droplet nucleation requires hydrophilicity, whereas the removal of droplets benefits from superhydrophobicity. The polydopamine micropatterned superhydrophobic surfaces described herein can integrate these two properties into one surface, leading to a better water collection performance than their uniformly superhydrophilic and superhydrophobic counterparts. The results also demonstrated that the micropatterned superhydrophobic surface with pattern dimensions of about a 500 μm pattern size with about 1000 mm separation distance had the highest water collection efficiency. It was also observed that the polydopamine-patterned superhydrophobic substrate with a pattern size of about 200 μm and a pattern separation of about 1000 μm showed a water collection efficiency only slightly higher than that of the uniformly superhydrophobic surface. This is probably a result of the relatively small fraction (about 5%) of superhydrophilic area compared with that of the polydopamine-patterned superhydrophobic substrates with a pattern size of about 200 μm and a pattern separation of about 400 μm (16%), and those with a pattern size of about 500 μm and a pattern separation of about 1000 μm (25%).

As will be apparent to those of skill in the art upon reading this disclosure, each of the individual embodiments described and illustrated has discrete components and features which may be readily separated from or combined with the features of any of the other several embodiments without departing from the scope or spirit of the present disclosure. Any recited method can be carried out in the order of events recited or in any other order logically possible.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A superhydrophobic surface comprising:
one or more superhydrophilic regions on at least part of the superhydrophobic surface, where the superhydrophilic regions comprise polydopamine.

2. The superhydrophobic surface of claim 1, wherein the superhydrophobic surface is deposited on a substrate.

3. The superhydrophobic surface of claim 2, wherein the substrate is a solid or a semi-solid substrate.

4. The superhydrophobic surface of claim 2, wherein the substrate is a solid substrate and the solid substrate comprises at least one compound selected form the group consisting of: glass, metal, metal oxide, plastic, and combinations thereof.

5. The superhydrophobic surface of claim 2, wherein substrate is a semi-solid substrate and the semi-solid substrate comprises at least one of compounds selected from the group consisting of: an organic gel, a polymer gel, rubber, an elastomer, and combinations thereof.

6. The superhydrophobic surface of claim 1, wherein the superhydrophobic surface contains air pockets within a three dimensional structure of the superhydrophobic surface.

7. The superhydrophobic surface of claim 1, wherein the superhydrophobic surface comprises at least one compound selected from the group consisting of: glass, metal, metal oxide, plastic, and combinations thereof.

8. The superhydrophobic surface of claim 1, wherein the superhydrophilic regions form micropatterns on the superhydrophobic surface.

9. The superhydrophobic surface of claim 8, wherein the micro patterns include one or more features and a size of one dimension of each of the one or more features is above 5 nm.

10. The superhydrophobic surface of claim 8, wherein the micro patterns include one or more features and the one or more features are microdots, microlines, or combinations thereof.

11. The superhydrophobic surface of claim 8, wherein the micro patterns include one or more features and the one or more features are discrete from each other and are separated from each other by the superhydrophobic surface.

12. The superhydrophobic surface of claim 8, wherein the micropatterns include at least two features and the at least two features are in direct contact with one another and are not separated by the superhydrophobic surface or a hydrophobic surface at a point within each of the at least two features.

13. A composition comprising:
a hydrophilic species; and
a tri-solvent,
wherein the first solvent of the tri-solvent is water or a tris buffer,
wherein the second solvent of the tri-solvent is selected from the group consisting of ethanol, propanol, methanol, acetone, tetrahydrofuran and isopropanol, and
wherein the third solvent of the tri-solvent is selected from the group consisting of: ethylene glycol, glycerol, dimethyl sulfoxide, and dimethylformamide.

14. A method of modifying a superhydrophobic surface, the method comprising:
depositing a composition on a region of the superhydrophobic surface, wherein the composition comprises a hydrophilic species and a solvent; and
incubating the superhydrophobic surface having the deposited composition, wherein the incubating continues until the composition is substantially polymerized to form a superhydrophilic region on the superhydrophobic surface.

15. The method of claim 14, wherein the hydrophilic species is selected from the group consisting of dopamine, dopamine-quinone, alpha-methyldopamine, norepinephrine, 3,4-dihydroxyphenylalaninie (DOPA), L-DOPA, alpha-DOPA, droxidopa, 5-hydroxydopamine, and combinations thereof.

16. The method of claim 14, wherein the solvent consists of at least one of the following: water, ethanol, methanol, isopropanol, propanol, acetone, tetrahydrofuran, dimethsulfoxide, nitromethane, pyridine, ethylene glycol, diethylene glycol, glycerol, dimethylformamide, and combinations thereof.

17. The method of claim 14, wherein the incubating step occurs for about 1 hour to about 72 hours.

18. The method of claim 14, wherein the step of depositing the composition occurs via a physical deposition method.

19. The method of claim 18, wherein the physical deposition method is selected from at least one method selected from the group consisting of: inkjet printing, dip-pen lithography, microcontact printing, and spraying.
